(19) United States
(12) Patent Application Publication
(10) Pub. No.: US 2013/0293154 A1
(43) Pub. Date: Nov. 7, 2013

(54) LIGHT EMITTING ELEMENT DRIVING CIRCUITS WITH DIMMING FUNCTION AND CONTROL METHODS THEREOF

(71) Applicant: CHENGDU MONOLITHIC POWER SYSTEMS CO., LTD., Chengdu (CN)

(72) Inventors: Naixing Kuang, Hangzhou (CN); Zhijun Ye, Hangzhou (CN); Kun Yi, Chengdu (CN); Bo Yu, Hangzhou (CN)

(73) Assignee: CHENGDU MONOLITHIC POWER SYSTEMS CO., LTD., Chengdu (CN)

(21) Appl. No.: 13/886,242

(22) Filed: May 2, 2013

(30) Foreign Application Priority Data
May 4, 2012 (CN) 201210134864.3

(51) Int. Cl. H05B 33/08

(52) U.S. Cl. CPC H05B 33/0815
USPC 315/307

(57) ABSTRACT

A controller used in a light emitting element driving circuit, wherein the light emitting element driving circuit has a power converter configured to provide an output current for the light emitting element. The controller has a dimming processing unit and a current control unit. The dimming processing unit is configured to receive a first dimming signal with a first duty cycle and a second dimming signal with a second duty cycle, and to generate a second dimming processing signal relative to the product of the first duty cycle and the second duty cycle. The current control unit is coupled between the dimming processing unit and the power converter, and is configured to generate a control signal for the power converter based on the second dimming processing signal and a feedback signal indicating the output current.

### CROSS-REFERENCE TO RELATED APPLICATION(S)

This application claims the benefit of CN application No. 201210134864.3, filed on May 4, 2012, and incorporated herein by reference.

### TECHNICAL FIELD

The present invention generally relates to electronic circuits, and more particularly but not exclusively to light emitting element driving circuits with dimming function and control methods thereof.

### BACKGROUND

For applications that utilize light emitting diodes (LED) as energy-saving light sources, it is important to adjust the brightness of the LED. Generally, a PWM dimming signal is generated based on the traffic, sunlight or image condition, and is provided to a LED driving circuit to adjust the brightness of the LED. A maximum LED current I_{MAX} flowing through the LED determines the maximum brightness. The LED driving circuit is configured to adjust the brightness of the LED by controlling the average current flowing through the LED based on the PWM dimming signal.

However, in some applications, only one PWM dimming signal is not enough. For example, for LED display, users may want to adjust the relative brightness. That is, the brightness of the LED is not only variable along with the image, but also adjusted based on the requirement of users. Therefore, a LED driving circuit which can adjust the brightness based on dual PWM dimming signals is desirable.

### SUMMARY

Embodiments of the present invention are directed to a controller used in a light emitting element driving circuit. The driving circuit comprises a power converter configured to provide an output current for the light emitting element. The controller comprises a dimming processing unit and a current control unit. The dimming process unit is configured to receive a first dimming signal with a first duty cycle and a second dimming signal with a second duty cycle, and to generate a second dimming processing signal relative to the product of the first duty cycle and the second duty cycle. The current control unit is coupled between the dimming processing unit and the power converter, and is configured to receive the second dimming processing signal and a feedback signal indicating the output current. Based on the second dimming processing signal and the feedback signal, the current control unit generates a control signal for the power converter.

### BRIEF DESCRIPTION OF THE DRAWINGS

The present invention can be further understood with reference to the following detailed description and the appended drawings, wherein like elements are provided with like reference numerals.

FIG. 1 schematically illustrates a block diagram of a LED driving circuit 100 in accordance with an embodiment of the present invention.

FIG. 2 schematically illustrates a block diagram of a dimming processing unit 210 in accordance with an embodiment of the present invention.

FIG. 3 schematically illustrates a dimming processing unit 310 in accordance with an embodiment of the present invention.

FIG. 4 schematically illustrates a dimming processing unit 410 in accordance with another embodiment of the present invention.

FIG. 5 schematically illustrates a dimming processing unit 510 in accordance with still another embodiment of the present invention.

FIG. 6 schematically illustrates a LED driving circuit 600 in accordance with an embodiment of the present invention.

FIG. 7 schematically illustrates a LED driving circuit 700 in accordance with another embodiment of the present invention.

FIG. 8 is a flow chart of a control method 800 used in a LED driving circuit in accordance with an embodiment of the present invention.

### DETAILED DESCRIPTION

Various embodiments of the technology will now be described. In the following description, some specific details, such as example circuits and example values for these circuit components, are included to provide a thorough understanding of embodiments. One skilled in the relevant art will recognize, however, that the technology can be practiced without one or more specific details, or with other methods, components, materials, etc. In other instances, well-known structures, or operations are not shown or described in detail to avoid obscuring aspects of the technology. As used hereinafter, the term “couple” generally includes a direct connection and an indirect connection.

In the following description, a LED driving circuit is used as an example. However, one with ordinary skill in the relevant art should know that the invention is not limited by the specific examples disclosed herein, the invention can be applied in other suitable light emitting elements.

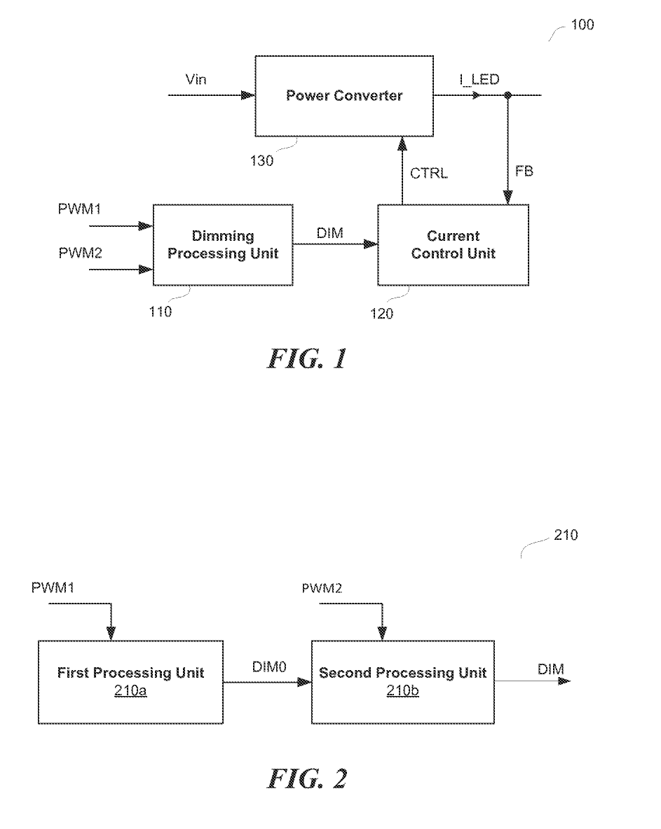

FIG. 1 schematically illustrates a block diagram of a LED driving circuit 100 in accordance with an embodiment of the present invention. The LED driving circuit 100 comprises a controller and a power converter 130. The controller comprises a dimming processing unit 110 and a current control unit 120. The power converter 130 comprises at least one switch. The power converter 130 may be configured in any isolated or non-isolated DC/DC topology, such as synchronous or asynchronous step-up converter, step-down converter, LDO and so on. The power converter 130 is configured to provide an output current I_LED to a LED load. In one embodiment, the LED load is a single light emitting diode. In another embodiment, the LED Load is a LED string. In other embodiments, the LED load may have other structure.

As shown in FIG. 1, the dimming processing unit 110 has a first input terminal, a second input terminal and an output terminal, wherein the first input terminal is coupled to receive a first dimming signal PWM1 with a first duty cycle D1, the second input terminal is coupled to receive a second dimming signal PWM2 with the second duty cycle D2. Based on the first dimming signal PWM1 and the second dimming signal PWM2, the dimming processing unit 110 generates a second dimming processing signal DIM at its output terminal. The second dimming processing signal DIM is relative to the product of the first duty cycle D1 and the second duty cycle D2. In one embodiment, the second dimming processing signal DIM is proportional to the product of the first duty cycle D1 and the second duty cycle D2. In order to achieve the desired brightness control, the output current I_LED provided to the LED load is adjusted based on the second dimming processing signal DIM. In one embodiment, the first dimming signal PWM1 is relative to image condition. In other embodiments, the first dimming signal PWM1 is relative to the traffic, sunlight or environmental condition and so on. In one embodiment, the second dimming signal PWM2 is provided by users. In other embodiments, the second dimming signal PWM2 may be other dimming signals used to adjust the relative brightness of the LED.

The current control unit 120 has a first input terminal, a second input terminal and an output terminal, wherein the first input terminal is coupled to the output terminal of the dimming processing unit 110 to receive the second dimming processing signal DIM, the second input terminal is coupled to receive a feedback signal FB indicating the output current I_LED, and wherein based on the second dimming processing signal DIM and the feedback signal FB, the current control unit 120 generates a control signal CTRL for the power converter at the output terminal.

FIG. 2 schematically illustrates a block diagram of a dimming processing unit 210 in accordance with an embodiment of the present invention. As shown in FIG. 2, the dimming processing unit 210 adopts two cascaded processing units, which comprises a first processing unit 210a and a second processing unit 210b.

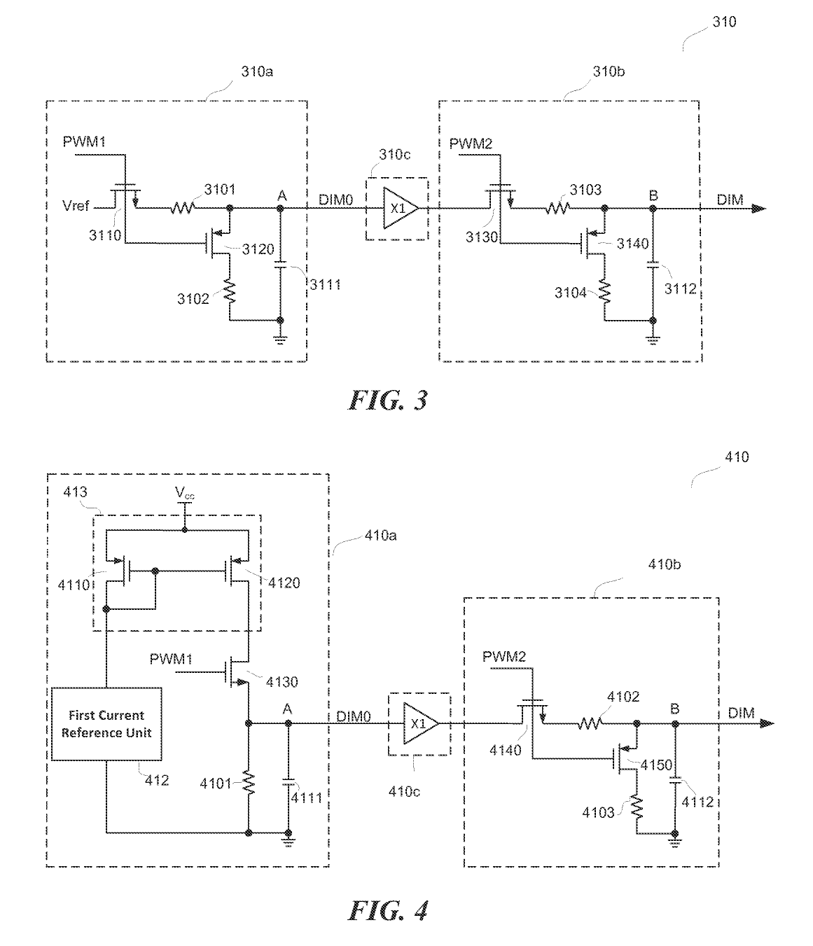

The first processing unit 210a has an input terminal and an output terminal, wherein the input terminal is coupled to receive the first dimming signal PWM1. Based on the first dimming signal PWM1, the first processing unit 210a generates a first dimming processing signal DIM0 proportional to the first duty cycle D1 at its output terminal. The second processing unit 210b has a first input terminal, a second input terminal and an output terminal, wherein the first input terminal is coupled to the output terminal of the first processing unit 210a to receive the first dimming processing signal DIM0, the second input terminal is coupled to receive the second dimming signal PWM2. Based on the first dimming processing signal DIM0 and the second dimming signal PWM2, the second processing unit 210b generates the second dimming processing signal DIM proportional to the product of the first duty cycle D1 and the second duty cycle D2. The details of the embodiments are described below with reference to FIGS. 3-5.

FIG. 3 schematically illustrates a dimming processing unit 310 in accordance with an embodiment of the present invention. The dimming processing unit 310 comprises a first processing unit 310a and the second processing unit 310b. The first processing unit 310a comprises a first switching transistor 3110, a second switching transistor 3120 and a capacitor 3111. As shown in the embodiment of FIG. 3, the first processing unit 310a may further comprise resistors 3101 and 3102.

As shown in FIG. 3, the first switching transistor 3110 has a drain terminal, a source terminal and a gate terminal, wherein the drain terminal is coupled to a reference voltage Vref, the gate terminal is coupled to receive the first dimming signal PWM1. The second switching transistor 3120 has a drain terminal, a source terminal and a gate terminal, wherein the source terminal is coupled to the source terminal of the first switching transistor 3110 through the resistor 3101, the drain terminal is grounded through the resistor 3102, and the gate terminal is coupled to receive the first dimming signal PWM1. The capacitor 3111 has a first terminal and a second terminal, wherein the first terminal is coupled to the source terminal of the second switching transistor 3120, the second terminal is grounded.

In operation, the first switching transistor 3110 and the second switching transistor 3120 are turned ON and OFF complementarily based on the first dimming signal PWM1.

When the first dimming signal PWM1 is high level, the first switching transistor 3110 is turned ON and the second switching transistor 3120 is turned OFF. The capacitor 3111 is charged by the reference voltage Vref through the resistor 3101. When the first dimming signal PWM1 is low level, the second switching transistor 3120 is turned ON, and the first switching transistor 3110 is turned OFF. The capacitor 3111 is discharged through the resistor 3102. In this way, the first dimming processing signal DIM0 proportional to the first duty cycle D1 is obtained at a node A. In the embodiment shown in FIG. 3, the resistance of the resistors 3101 and 3102 are equal, the first dimming processing signal DIM0=Vref*D1. In other embodiments, the first dimming processing signal DIM0 may be other values relative to the first duty cycle D1.

As shown in FIG. 3, the topology of the second processing unit 310b is similar to that of the first processing unit 310a. The second processing unit 310b comprises a third switching transistor 3130, a fourth switching transistor 3140 and a capacitor 3112. In the embodiment shown in FIG. 3, the second processing unit 310b further comprises resistors 3103 and 3104. In one embodiment, the resistance of the resistors 3103 and 3104 are equal. In one embodiment, the resistors 3101˜3104 may comprise discrete devices, In other embodiments, the resistors 3101˜3104 be realized by part of an integrated circuit.

The third switching transistor 3130 has a drain terminal, a source terminal and a gate terminal, wherein the drain terminal is coupled to receive the first dimming processing signal DIM0, the gate terminal is coupled to receive the second dimming signal PWM2. The fourth switching transistor 3140 has a drain terminal, a source terminal and a gate terminal, wherein the drain terminal is grounded through the resistor 3104, the gate terminal is coupled to receive the second dimming signal PWM2, the source terminal is coupled to the source terminal of the third switching transistor 3130. The capacitor 3112 has a first terminal and a second terminal, wherein the first terminal is coupled to the source terminal of the fourth switching transistor 3140, and the second terminal is grounded.

Since the topology of the second processing unit 310b is similar to that of the first processing unit 310a, the operating principle of the second processing unit 310b is omitted for clarity. As shown in FIG. 3, the second dimming processing signal DIM proportional to the product of the first duty cycle D1 and the second duty cycle D2 is obtained at a node B.

Based on the second dimming processing signal DIM and the feedback signal FB indicating the output current, the average current flowing through the LED load is adjusted to be proportional to the product of the first duty cycle D1 and the second duty cycle D2. And hence the relative brightness of LED can be adjusted. In addition, in the embodiment shown in FIG. 3, the first dimming signal PWM1 and that of the second dimming signal PWM2 may be not synchronized.

In one embodiment, the dimming processing unit 310 further comprises a buffer 310c which is coupled between the first processing unit 310a and the second processing unit 310b. The buffer 310c may comprise a unity-gain buffer, i.e. it has a voltage gain of one. In other embodiments, the voltage gain of buffer 310c may be other values. In one embodiment, the buffer 310c may comprise a voltage follower.

FIG. 4 schematically illustrates a dimming processing unit 410 in accordance with another embodiment of the present invention. The processing unit 410 comprises a first processing unit 410a and a second processing unit 410b. In addition, the dimming processing unit 410 further comprises a buffer 410c coupled between the first processing unit 410a and the second processing unit 410b.

As shown in FIG. 4, the first processing unit 410a comprises a first current reference unit 412, a first current mirror 413, a switching transistor 4130, a resistor 4101 and a capacitor 4111. The first current mirror 413 has an input terminal, a supply terminal and an output terminal, wherein the input terminal is coupled to the first current reference unit 412 to receive a first input current, the supply terminal is coupled to a supply voltage V_{CC}. Based on the first input current, the first current mirror 413 generates a first output current proportional to the first input current at the its output terminal. In one embodiment, the first current mirror 413 comprises transistors 4110 and 4120. In other embodiment, the first current mirror 413 may comprise other suitable circuit, device or structure.

The first current reference unit 412 is configured to provide the first input current for the first current mirror 413. In one embodiment, the first current reference unit 412 comprises a constant current source coupled between the first current mirror 413 and ground. In another embodiment, the first input current is relative to a reference voltage Vref. The first current reference unit 412 comprises a switching transistor, an operational amplifier and a resistor. The switching transistor has a source terminal, a drain terminal and a gate terminal. Wherein the source terminal of the switching transistor is grounded through the resistor, the drain terminal is coupled to the input terminal of the first current mirror 413. The operational amplifier has a non inverting input terminal, an inverting input terminal and an output terminal, wherein the non inverting input terminal is coupled to the reference voltage Vref, the inverting input terminal is coupled to the source terminal of the switching transistor, and the output terminal is coupled to the gate terminal of the switching transistor. In other embodiments, the first current reference unit 412 comprises other suitable components or circuits.

The switching transistor 4130 has a source terminal, a drain terminal and a gate terminal, wherein the drain terminal is coupled to the output terminal of the first current mirror 413, the source terminal is coupled to ground through the resistor 4101, the gate terminal is coupled to receive the first dimming signal PWM1. The capacitor 4111 has a first terminal and a second terminal, wherein the first terminal is coupled to the source terminal of the switching transistor 4130, and the second terminal is grounded.

In operation, when the first dimming signal PWM1 is high level, the switching transistor 4130 is turned ON, the first output current of the first current mirror 413 flows through the switching transistor 4130, the capacitor 4111 is charged. When the first dimming signal PWM1 is low level, the switching transistor 4130 is turned OFF, the capacitor 4111 is discharged through the resistor 4101. In this way, the first dimming processing signal DIM0 is obtained at the first terminal of the capacitor 4111 (node A as shown in FIG. 4). In one embodiment, the first dimming signal DIM0=I1*D1*k, wherein I1 is the first input current provided by the first current reference unit 412, k is the scale factor of the first current mirror 413. In a further embodiment, the first dimming processing signal DIM0=Vref*D1.

As shown in FIG. 4, the topology of the second processing unit 410b is same to that of the second processing unit 310b shown in FIG. 3. The second processing unit 410b comprises switching transistors 4140, 4150, and the capacitor 4112. The second processing unit 410b further comprises resistors 4102 and 4103. The second processing unit 410b has a first input terminal, a second input terminal and an output terminal, wherein the first input terminal is coupled to the output terminal of the first processing unit 410a to receive the first dimming processing signal DIM0, the second input terminal is coupled to the second dimming signal PWM2. The second processing unit 410b generates the second dimming processing signal DIM at its output terminal (node B), wherein the second dimming processing signal DIM=DIM0*D2. In one embodiment, the second dimming processing signal DIM=DIM0*D2=Vref*D1*D2.

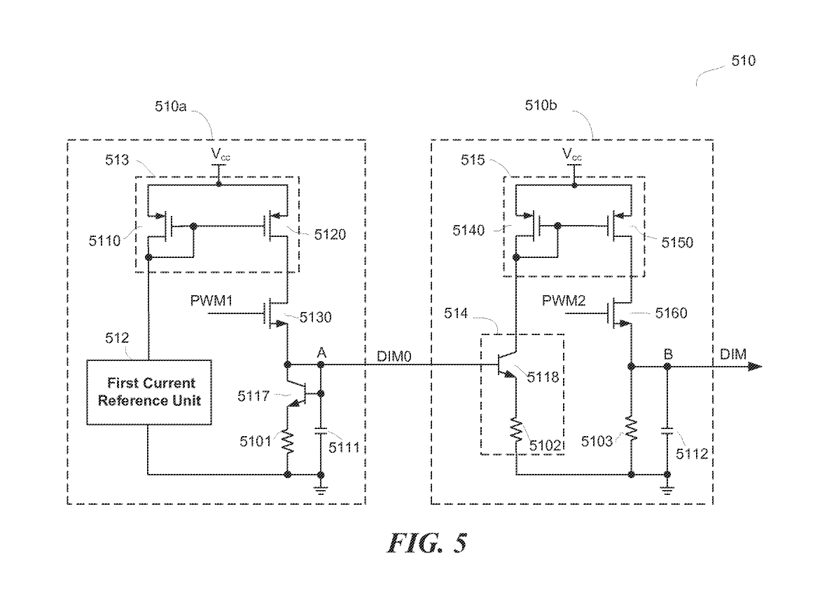

FIG. 5 schematically illustrates a dimming processing unit 510 in accordance with still another embodiment of the present invention. As shown in FIG. 5, the topology of the first processing unit 510a is similar to that of the first processing unit 410a shown in FIG. 4. The first processing unit 510a comprises a first current reference unit 512, a first current mirror 513, a switching transistor 5130, a resistor 5101 and a capacitor 5111. The first processing unit 510a further comprises a triode 5117. The triode 5117 has a base terminal, a collector terminal and an emitter terminal, wherein the base terminal and the collector terminal are coupled to the source terminal of the switching transistor 5130, the emitter terminal is coupled to ground through the resistor 5101. In one embodiment, the first current mirror 513 comprises transistors 5110 and 5120. The first processing unit 510a has an input terminal and an output terminal, wherein the input terminal is coupled to receive the first dimming signal PWM1. The first dimming processing unit 510a generates the first dimming processing signal DIM0 at its output terminal (node A), wherein the first dimming processing signal DIM0 is proportional to the first duty cycle D1.

The second processing unit 510b comprises the second current reference unit 514, the second current mirror 515, a switching transistor 5160, a resistor 5103 and a capacitor 5112. The second current mirror 515 comprises transistors 5140 and 5150. The second current mirror 515 has a supply terminal, an input terminal and an output terminal, wherein the supply terminal is coupled to the supply voltage V_{CC}, the input terminal is coupled to the output terminal of the second current reference unit 514 to receive a second input current. The second current mirror 515 generates a second output current proportional to the second input current at its output terminal. The second current reference unit 514 has a first terminal, a second terminal and an output terminal, wherein the first terminal is coupled to the output terminal of the first processing unit 510a to receive the first dimming processing signal DIM0, the second terminal is grounded, the output terminal is coupled to the input terminal of the second current mirror 515 to provide the second input current. In one embodiment, the second current reference unit 514 comprises a triode 5118 and a resistor 5102. The triode 5118 has a base terminal, a collector terminal and an emitter terminal, wherein the base terminal is coupled to the base terminal of the triode 5117, the collector terminal is coupled to the input terminal of the second current mirror 515, the emitter terminal is coupled to ground through the resistor 5102. The switching transistor 5160 has a drain terminal, a source terminal and a gate terminal, wherein the drain terminal is coupled to the output terminal of the second current mirror 515, the source terminal is coupled to ground through the resistor 5103, and the gate terminal is coupled to receive the second dimming signal PWM2. The capacitor 5112 has a first terminal and a second terminal, wherein the first terminal is coupled to the source terminal of switching transistor 5160, the second terminal is grounded. The second processing unit 510b generates the second dimming processing signal DIM at its output terminal (node B), wherein the second dimming processing signal DIM is proportional to the product of the first duty cycle D1 and the second duty cycle D2.

Even though particular combinations of the first processing unit and the second processing unit are shown in FIGS. 3-5, in other embodiments, the dimming processing unit may also include other combinations of the foregoing first and second processing units. In some embodiments, the first processing unit or the second processing unit may include additional and/or different components. For example, even though the switching transistors 3110 and 3120 respectively include a NMOS transistor and a PMOS transistor as shown in FIG. 3, in other embodiments, the switching transistors 3110 and 3120 may comprise any other type of switching transistors as long as the two switching transistors can work complementarily.

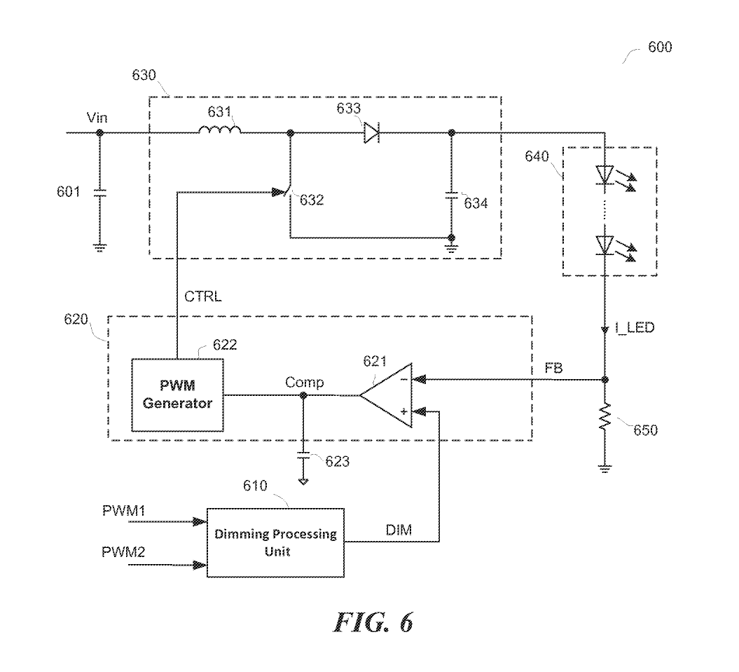

FIG. 6 schematically illustrates a LED driving circuit 600 in accordance with an embodiment of the present invention. The LED driving circuit 600 comprises a dimming processing unit 610, a current control unit 620 and a power converter 630. The dimming processing unit 610 may be configured in the topology shown in FIGS. 3-5. As shown in FIG. 6, the power converter 630 is configured in a boost converter that comprises an inductor 631, a switch 632, a diode 633 and an output capacitor 634. In other embodiments, the power converter 630 may be configured in other switching converter or LDO regulator. The LED load 640 comprises multiple LEDs connected in series. A resistor 650 has a first terminal and a second terminal, wherein the first terminal is coupled to the LED load 640, the second terminal is grounded. The resistor 650 is used to detect the output current I_LED flowing through the LED load 640, the voltage at the first terminal of the resistor 650 is the feedback signal FB indicating the output current I_LED.

The current control unit 620 comprises an error amplifier 621 and a PWM generator 622. The error amplifier 621 has a non-inverting input terminal, an inverting input terminal and an output terminal, wherein the inverting input terminal is coupled to the first terminal of the resistor 650 to receive the feedback signal FB, the non-inverting input terminal is coupled to the output terminal of the dimming processing unit 610 to receive the second dimming processing signal DIM. The output terminal of the error amplifier 621 is coupled to ground through the capacitor 623. Based on the second dimming processing signal DIM (e.g. Vref*D1*D2) and the feedback signal FB, the error amplifier 621 generates a compensation signal COMP at its output terminal.

The PWM generator 622 is configured to receive the compensation signal COMP and to generate a control signal CTRL to control the switch 632 in the power converter 630. The conventional PWM generation method may be used by the PWM generator 622 to generate the control signal CTRL, for example, the compensation signal COMP is compared with a triangle-wave signal to generate the control signal CTRL. Based on the control signal CTRL, the power converter 630 provides a stable output current I_LED for the LED load 640.

In one embodiment, the switch 632, the current control unit 620 and the dimming processing unit 610 are integrated in the same chip.

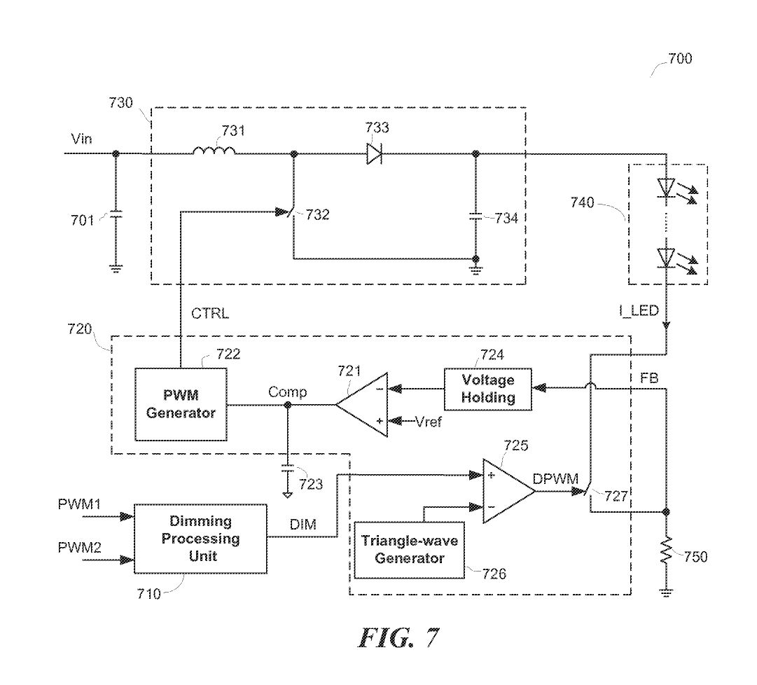

FIG. 7 schematically illustrates a LED driving circuit 700 in accordance with another embodiment of the present invention. The LED driving circuit 700 comprises a dimming processing unit 710, a current control unit 720 and a power converter 730. The dimming processing unit 710 may be configured in the topology shown in FIGS. 3˜5. The power converter 730 comprises an inductor 731, a switch 732, a diode 733 and an output capacitor 734. The power converter 730 is configured to provide an output current I_LED to the LED load 740. The LED load 740 comprises multiple LEDs connected in series.

As shown in FIG. 7, the current control unit 720 comprises an error amplifier 721 and a PWM generator 722. In addition, the current control unit 720 further comprises a comparator 725, a triangle-wave generator 726 and a dimming switch 727.

The triangle-wave generator 726 is configured to generate a triangle-wave signal with a fixed frequency. The non-inverting input terminal of the comparator 725 is coupled to the output terminal of the dimming processing unit 710 to receive the second dimming processing signal DIM, the inverting input terminal of the comparator 725 is coupled to the triangle-wave generator 726 to receive the triangle-wave signal. Based on the second dimming processing signal DIM and the triangle-wave signal, the comparator 725 generates the dimming control signal DPWM at its output terminal. The dimming switch 727 has a first terminal, a second terminal and a control terminal, wherein the first terminal is coupled to the LED load 740, the second terminal is coupled to ground through a resistor 750, and the control terminal is coupled to the output terminal of the comparator 725 to receive the dimming control signal DPWM. The resistor 750 has a first terminal and a second terminal, wherein the first terminal is coupled to the second terminal of the dimming switch 727, the second terminal is grounded. The resistor 750 is configured to detect the output current I_LED flowing through the LED load 740, the voltage at the first terminal of the resistor 750 is the feedback signal FB indicating the output current I_LED.

In one embodiment, the amplitude of the triangle-wave signal is Vref, the second dimming processing signal DIM=Vref*D1*D2, the duty cycle of the dimming control signal DPWM is the product of the first duty cycle D1 and the second duty cycle D2. The dimming switch 727 is turned ON and turned OFF quickly under the control of the dimming control signal DPWM, so as to make the average current I_{AVG} flowing through the LED load 740 be proportional to the duty cycle of the dimming control signal DPWM. In one embodiment, the average current I_{AVG}=I_{MAX}*D1*D2, wherein I_{MAX} is the maximum output current. In one embodiment, the maximum output current I_{MAX}=Vref/R, wherein R is the resistance of the resistor 750.

The error amplifier 721 has an inverting input terminal, a non-inverting input terminal and an output terminal, wherein the inverting input terminal is coupled to the second terminal of the dimming switch 727 to receive the feedback signal FB, the non-inverting input terminal is coupled to a reference voltage Vref, the output terminal is coupled to ground through the capacitor 723 to provide a compensation signal COMP. The PWM generator 722 is configured to receive the compensation signal COMP, and to generate a control signal CTRL to control the switch 732 in the power converter 730.

In one embodiment, the current control unit 720 further comprises a voltage holding module 724. The voltage holding module 724 has an input terminal and an output terminal, wherein the input terminal is coupled to the second terminal of the dimming switch 727, the output terminal is coupled to the inverting input terminal of the error amplifier 721.

The voltage holding module 724 is configured to receive a feedback signal FB indicating the output current and to keep its output signal constant when the dimming switch 727 is turned off.

In one embodiment, the dimming processing unit 710, the current control unit 720 and the switch 732 of the power converter 730 are integrated in the same chip.

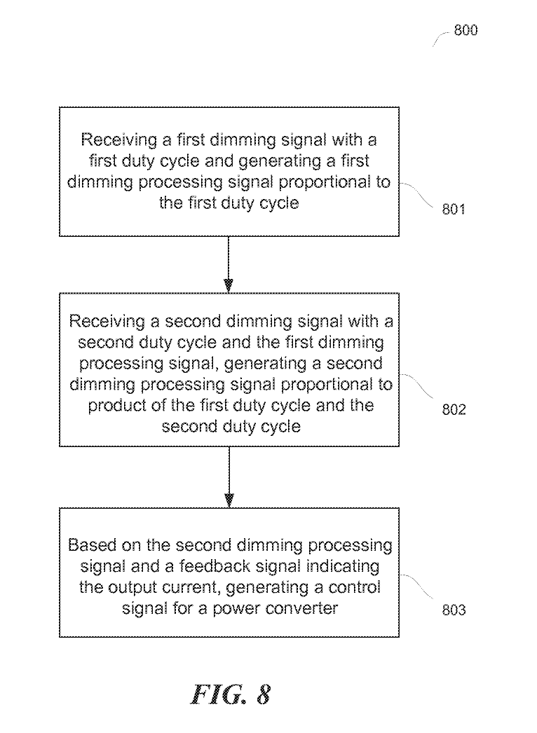

FIG. 8 is a flow chart of a control method 800 used in a LED driving circuit in accordance with an embodiment of the present invention, wherein the LED driving circuit comprises a power converter which provides output current for the LED load. The method comprises steps 801˜803.

At step 801, a first dimming signal PWM1 with a first duty cycle is received, and a first dimming processing signal DIM0 proportional to the first duty cycle is generated.

At step 802, the first dimming processing signal DIM0 and a second dimming signal PWM2 with a second duty cycle are received, and a second dimming processing signal proportional to the product of the first duty cycle and the second duty cycle is generated.

At step 803, based on the second dimming processing signal and a feedback signal indicating the output current, a control signal for the power converter is generated.

Obviously many modifications and variations of the present invention are possible in light of the above teachings. It is therefore to be understood that within the scope of the appended claims the invention may be practiced otherwise than as specifically described. It should be understood, of course, the foregoing invention relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim;

1. A controller used in a light emitting element driving circuit, wherein the light emitting element driving circuit comprises a power converter configured to provide an output current for the light emitting element, the controller comprises:
a dimming processing unit having a first input terminal, a second input terminal and an output terminal, wherein the first input terminal is coupled to receive a first dimming signal with a first duty cycle, the second input terminal is coupled to receive a second dimming signal with a second duty cycle, and wherein based on the first dimming signal and the second dimming signal, the dimming processing unit generates a second dimming processing signal relative to the product of the first duty cycle and the second duty cycle at the output terminal; and
a current control unit having a first input terminal, a second input terminal and an output terminal, wherein the first input terminal is coupled to the output terminal of the dimming processing unit to receive the second dimming processing signal, the second input terminal is coupled to receive a feedback signal indicating the output current, and wherein based on the second dimming processing signal and the feedback signal, the current control unit generates a control signal for the power converter at the output terminal.

2. The controller of claim 1, wherein the dimming processing unit comprises:
a first processing unit having an input terminal and an output terminal, wherein the input terminal is coupled to receive the first dimming signal, and wherein based on the first dimming signal, the first processing unit generates a first dimming processing signal proportional to the first duty cycle at the output terminal; and
a second processing unit having a first input terminal, a second input terminal and an output terminal, wherein the first input terminal is coupled to the output terminal of the first processing unit to receive the first dimming processing signal, the second input terminal is coupled to receive the second dimming signal, and wherein based on the first dimming processing signal and the second dimming signal, the second processing unit generates the second dimming processing signal proportional to the product of the first duty cycle and the second duty cycle at the output terminal.

3. The controller of claim 2, wherein the first processing unit comprises:
a first switching transistor having a first terminal, a second terminal and a control terminal, wherein the first terminal is coupled to receive a reference voltage, the control terminal is coupled to receive the first dimming signal;
a second switching transistor having a first terminal, a second terminal and a control terminal, wherein the first terminal is coupled to the second terminal of the first switching transistor, the second terminal is grounded, the control terminal is coupled to receive the first dimming signal; and
a first capacitor having a first terminal and a second terminal, wherein the first terminal is coupled to the first terminal of the second switching transistor, the second terminal is grounded, and the first terminal of the first capacitor is configured as the output terminal of the first processing unit to provide the first dimming processing signal.

4. The controller of claim 2, wherein the second processing unit comprises:
a third switching transistor having a first terminal, a second terminal and a control terminal, wherein the first terminal is coupled to receive the first dimming processing signal, the control terminal is coupled to receive the second dimming signal;
a fourth switching transistor having a first terminal, a second terminal and a control terminal, wherein the first terminal is coupled to the second terminal of the third switching transistor, the second terminal is grounded, the control terminal is coupled to receive the second dimming signal; and
a second capacitor having a first terminal and a second terminal, wherein the first terminal is coupled to the first terminal of the fourth switching transistor, the second terminal is grounded, the first terminal of the second capacitor is configured as the output terminal of the second processing unit to provide the second dimming processing signal.

5. The controller of claim 2, wherein the first processing unit comprises:
a first current reference unit having a first terminal and a second terminal, wherein the second terminal is grounded, the first current reference unit is configured to provide a first input current;
a first current mirror having a supply terminal, an input terminal and an output terminal, wherein the supply terminal is coupled to a supply voltage, the input terminal is coupled to the first terminal of the first current reference unit to receive the first input current;
a fifth switching transistor having a first terminal, a second terminal and a control terminal, wherein the first terminal is coupled to the output terminal of the first current mirror, the second terminal is grounded through a first resistor, the control terminal is coupled to receive the first dimming signal; and
a third capacitor having a first terminal and a second terminal, wherein the first terminal is coupled to the second terminal of the fifth switching transistor, the second terminal is grounded, the first terminal of the third capacitor is configured as the output terminal of the first processing unit to provide the first dimming processing signal.

6. The controller of claim 2, wherein the second processing unit comprises:
a second current reference unit having a first terminal, a second terminal and an output terminal, wherein the first terminal is coupled to the output terminal of the first processing unit to receive the first dimming processing signal, the second terminal is grounded, the second current reference unit is configured to provide a second input current;
a second mirror having a supply terminal, an input terminal and an output terminal, wherein the supply terminal is coupled to the supply voltage, the input terminal is coupled In the output terminal of the second current reference unit to receive the second input current;
a sixth switching transistor having a first terminal, a second terminal and a control terminal, wherein the first terminal is coupled to the output terminal of the second current mirror, the second terminal is grounded through a second resistor, and the control terminal is coupled In receive the second dimming signal; and
a fourth capacitor having a first terminal and a second terminal, wherein the first terminal is coupled to the second terminal of the sixth switching transistor, the second terminal is grounded, the first terminal of the fourth capacitor is configured as the output terminal of the second processing unit to provide the second dimming processing signal.

7. The controller of claim 6, wherein the second current reference unit comprises:
a triode having a first terminal, a second terminal and a control terminal, wherein the first terminal is coupled to the input. terminal of the second current mirror, the control terminal is coupled to the output terminal of the first processing unit to receive the first dimming processing signal; and
a third resistor coupled between the second terminal of he triode and ground.

8. The controller of claim 2, wherein the dimming processing unit further comprises a buffer coupled between the first processing unit and the second processing unit.

9. A control method used in a light emitting element driving circuit, wherein the light emitting element driving circuit comprises a power converter configured to provide an output current for the light emitting element, the control method comprises:
receiving a first dimming signal with a first duty cycle and generating a first dimming processing signal proportional to the first duty cycle;
receiving the first dimming processing signal and a second dimming signal with a second duty cycle, and generating a second dimming processing signal proportional to the product of the first duty cycle and the second duty cycle; and
generating a control signal for the power converter based on the second dimming processing signal and a feedback signal indicating the output current.

10. A light emitting element driving circuit comprising:
a power converter configured to provide an output current for the light emitting element;
a dimming processing unit having a first input terminal, a second input terminal and an output terminal, wherein the first input terminal is coupled to receive a first dimming signal with a first duty cycle, the second input terminal is coupled to receive a second dimming signal with a second duty cycle, and wherein based on the first dimming signal and the second dimming signal, the dimming processing unit generates a second dimming processing signal relative to the product of the first duty cycle and the second duty cycle at the output terminal; and
a current control unit having a first input terminal, a second input terminal and an output terminal, wherein the first input terminal is coupled to the output terminal of the dimming processing unit to receive the second dimming processing signal, the second input terminal is coupled to receive a feedback signal indicating the output current, and wherein based on the second dimming processing signal and the feedback signal, the current control unit generates a control signal for the power converter at the output terminal.

11. The driving circuit of claim 10, wherein the dimming processing unit Comprises:
a first processing unit having an input terminal and an output terminal, wherein the input terminal is coupled to receive the first dimming signal, and wherein based on the first dimming signal, the first processing unit generates a first dimming processing signal proportional to the first duty cycle at the output terminal; and
a second processing unit having a first input terminal, a second input terminal and an output terminal, wherein the first input terminal is coupled to the output terminal of the first processing unit to receive the first dimming processing signal, the second input terminal is coupled to receive the second dimming signal, and wherein based on the first dimming processing signal and the second dimming signal, the second processing unit generates the second dimming processing signal proportional to the product of the first duty cycle and the second duty cycle at the output terminal.

12. The driving circuit of claim 11, wherein the first processing unit comprises:
a first switching transistor having a first terminal, a second terminal and a control terminal, wherein the first terminal is coupled to receive a reference voltage, the control terminal is coupled to receive the first dimming signal;
a second switching transistor having a first terminal, a second terminal and a control terminal, wherein the first terminal is coupled to the second terminal of the first switching transistor, the second terminal is grounded, the control terminal is coupled to receive the first dimming signal; and
a first capacitor having a first terminal and a second terminal, wherein the first terminal is coupled to the first terminal of the second switching transistor, the second terminal is grounded, and the first terminal of the first capacitor is configured as the output terminal of the first processing unit to provide the first dimming processing signal.

13. The driving circuit of claim 11, wherein the second processing unit comprises:
a third switching transistor having a first terminal, a second terminal and a control terminal, wherein the first terminal is coupled to receive the first dimming processing signal, the control terminal is coupled to receive the second dimming signal;
a fourth switching transistor having a first terminal, a second terminal and a control terminal, wherein the first terminal is coupled to the second terminal of the third switching transistor, the second terminal is grounded, the control terminal is coupled to receive the second dimming signal; and
a second capacitor having a first terminal and a second terminal, wherein the first terminal is coupled to the first terminal of the fourth switching transistor, the second terminal is grounded, the first terminal of the second capacitor is configured as the output terminal of the second processing unit to provide the second dimming processing signal.

14. The driving circuit of claim 11, wherein the first processing unit comprises:
a first current reference unit having a first terminal and a second terminal, wherein the second terminal is grounded, the first current reference unit is configured to provide a first input current;
a first current mirror, having a supply terminal, an input terminal and an output terminal, wherein the supply terminal is coupled to a supply voltage, the input terminal is coupled to the first terminal of the first current reference unit to receive the first input current;
a fifth switching transistor having a first terminal, a second terminal and a control terminal, wherein the first terminal is coupled to the output terminal of the first current mirror, the second terminal is grounded through a first resistor, the control terminal is coupled to receive the first dimming signal; and
a third capacitor having a first terminal and a second terminal, wherein the first terminal is coupled to the second terminal of the fifth switching transistor, the second terminal is grounded, the first terminal of the third capacitor is configured as the output terminal of the first processing unit to provide the first dimming processing signal.

15. The driving circuit of claim 11, wherein the second processing unit comprises:
a second current reference unit having a first terminal, a second terminal and an output terminal, wherein the first terminal is coupled to the output terminal of the first processing unit to receive the first dimming processing signal, the second terminal is grounded, the second current reference unit is configured to provide a second input current;
a second mirror having a supply terminal, an input terminal and an output terminal, wherein the supply terminal is coupled to the supply voltage, the input terminal is coupled to the output terminal of the second current reference unit to receive the second input current;
a sixth switching transistor having a first terminal, a second terminal and a control terminal, wherein the first terminal is coupled to the output terminal of the second current mirror, the second terminal is grounded through a second resistor, and the control terminal is coupled to receive the second dimming signal; and
a fourth capacitor having a first terminal and a second terminal, wherein the first terminal is coupled to the second terminal of the sixth switching transistor, the second terminal is grounded, the first terminal of the fourth capacitor is configured as the output terminal of the second processing unit to provide the second dimming processing signal.

16. The driving circuit of claim 15, wherein the second current reference unit comprises:
a triode having a first terminal, a second terminal and a control terminal, wherein the first terminal is coupled to the input terminal of the second current mirror, the control terminal is coupled to the output terminal of the first processing unit to receive the first dimming processing signal; and
a third resistor coupled between the second terminal of the triode and ground.

17. The driving circuit of claim 11, wherein the dimming processing unit further comprises a buffer coupled between the first processing unit and the second processing unit.

18. The driving circuit of claim 10, wherein the current control unit comprises:
an error amplifier having a non-inverting input terminal, an inverting input terminal and an output terminal, wherein the inverting input terminal is coupled to receive the feedback signal, the non-inverting input terminal is coupled to the output terminal of the dimming processing unit to receive the second dimming processing signal, and wherein based on the second dimming processing signal and the feedback signal, the error amplifier generates a compensation signal at the output terminal; and
a PWM generator having an input terminal and an output terminal, wherein the input terminal is configured to receive the compensation signal, the PWM generator generates the control signal for the power converter at the output terminal based on the compensation signal.

19. The driving circuit of claim 10, wherein the current control unit comprises:
a triangle-wave generator configured to generate a triangle-wave signal with a fixed frequency;
a comparator having a first input terminal, a second input terminal and an output terminal, wherein the first input terminal is coupled to receive the second dimming processing signal, the second input terminal is configured to receive the triangle-wave signal, and wherein based on the second dimming processing signal and the triangle-wave signal, the comparator provides a dimming control signal at the output terminal;
a dimming switch having a first terminal, a second terminal and a control terminal, wherein the first terminal is coupled to the light emitting element, the second terminal is coupled to ground through a resistor, and the control terminal is coupled to the output terminal of the comparator to receive the dimming control signal;
an error amplifier having a non-inverting input terminal, an inverting input terminal and an output terminal, wherein the inverting input terminal is coupled to the second terminal of the dimming switch to receive the feedback signal, the non-inverting input terminal is coupled to receive a reference voltage, and wherein based on the reference voltage and the feedback signal, the error amplifier generates a compensation signal at the output terminal; and
a PWM generator having an input terminal and an output terminal, wherein the input terminal is configured to receive the compensation signal, the PWM generator generates the control signal for the power converter at the output terminal based on the compensation signal.
